(19) United States
(12) Patent Application Publication
(10) Pub. No.: US 2019/0108557 A1
(43) Pub. Date: Apr. 11, 2019

(54) SELECTING ITEMS FOR PRESENTATION VIA DYNAMIC SPONSORED CONTENT

(71) Applicant: Facebook, Inc., Menlo Park, CA (US)

(72) Inventors: Dinkar Jain, Menlo Park, CA (US); Ethan Batraski, Palo Alto, CA (US); Nikita Igorevych Lytkin, Sunnyvale, CA (US); Rachel Antoinette Hamilton, Palo Alto, CA (US); Shyamsundar Rajaram, San Francisco, CA (US)

(21) Appl. No.: 15/727,410

(22) Filed: Oct. 6, 2017

(51) Int. Cl. G06Q 30/02

(52) U.S. Cl. CPC G06Q 30/0277; G06Q 30/0275; G06Q 30/0269

(57) ABSTRACT

An online system selects items for display in content provided to users by considering the value of each item to third-party content providers as well as user's interests. The online system receives a catalog including items that are each associated with weights from a third-party content provider for inclusion in sponsored content to be presented to users of an online system. The weights have values indicating measures of importance of the items to the third-party content provider on a per-item basis. The online system identifies a request for sponsored content, and selects one or more items from the catalog for inclusion in a dynamic sponsored content item. The online system calculates a weighted user preference score using a weight associated with an item and affinity information describing the user's affinity for the item.

### BACKGROUND

This disclosure relates generally to presenting content to users of an online system, and more specifically to selecting which items to include in dynamic sponsored content based on value of the particular item to the content provider.

Online systems, such as social networking systems, allow users to communicate with other users of the online system. Many online systems allow third-party content providers (e.g., businesses) to sponsor presentation of content on an online system to gain public attention for the content or to persuade other users to take actions. Conventional online systems typically present sponsored content items to users solely based on users' interests. For example, for a particular user, an online system evaluates a likelihood of the user interacting with different sponsored content items, and selects and presents the one with which the user is most likely to interact. However, this provision of sponsored content items completely disregards or greatly discounts third-party interests. For example, a third-party content provider benefits to different degrees from presentation of different content items where the content provider has some control over what content is shown in the content item.

### SUMMARY

An online system allows a third party content provider to indicate the value or importance of different items from the third party content provider that might appear in content that the online system provides for display to its users, and this importance can be stated on a per-item level. The online system can thus select an item to include in dynamically-generated content based on the third party content provider's stated importance of that item, given the third party content provider has some control over which items are selected.

The third-party content provider provides to the online system a catalog of products that might appear in a content item, where some of the items may be of more importance than the others to the third-party content provider and the third-party content provider indicates in the catalog the relative importance of each item on a per-item basis. An importance of the item to a third-party content provider is correlated to an amount of value returned to the third-party content provider if the user has an interest in the item.

The online system provides the third-party content provider with control over presentation of sponsored content at an item level (as opposed to per group of items or per type of item) by allowing providers to specify preferences for certain items to appear in sponsored content items that the online system will present to its users. Each item may be associated with a weight indicating a measure of importance of the item to the third-party content provider. The online system identifies a request for sponsored content from a client device of a user of the online system. The online system determines candidate sponsored content items that can be used to fulfill the request. For example, the user meets the targeting criteria specified in each candidate sponsored content item. At least one of the candidate content items is a dynamic sponsored content item in which the online system dynamically selects the item from the catalog to include in the dynamic sponsored content at the time of providing the content for display to the user.

When selecting the item for the dynamic sponsored content item, the online system accounts for the importance of the item to the third-party content provider in addition to the particular user's affinity for the item. In particular, for each item in a catalog considered for the dynamic sponsored content item, the online system retrieves affinity information indicating affinity of the user for those types of items. The online system calculates a weighted user preference score based on the affinity information weighted by the weight associated with the item in the catalog. As such, the item is selected in a manner that accounts for the importance of the item to the third-party content provider. The online system determines bid prices for the candidate sponsored content items. The online system applies a selection process to select one of the candidate sponsored content items for presentation to the user. The online system provides for display to a client device the selected sponsored content item.

### BRIEF DESCRIPTION OF THE DRAWINGS

FIG. 1 is a block diagram of a system environment in which an online system operates, in accordance with an embodiment.

FIG. 2 is a block diagram of the online system of FIG. 1, in accordance with an embodiment.

FIG. 3 is a flow chart illustrating an example process of presenting dynamic sponsored content items, in accordance with an embodiment.

FIG. 4 illustrates an example of selecting products from a product catalog for inclusion in a dynamic content item, in accordance with an embodiment.

FIG. 5 illustrates an example presenting dynamic sponsored content items based on a product level bidding, in accordance with one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview

In order to increase the return-on-investment (ROI), the third-party content provider is inclined to promote or upsell the most valuable product such as a particular new product or the most expensive product in the catalog. Unfortunately, conventional social networking systems do not permit the third-party content provider to designate this selective promotion of products.

An online system selects one or more items (e.g., products, services, games, application installs, memberships, etc.) for promotion via dynamic sponsored content items on an individual product basis (instead of on a product set level). Content for which the online system receives compensation in exchange for presenting to users is referred to as a “sponsored content item.” As such, the online system accounts for an individual item's value, such as an individual product's value, to the third-party content providers thereby to increase a return-on-investment (ROI) for third-party content providers. A dynamic sponsored content item promotes one or more products that are selected from a product catalog. As described herein, the term “product” refers to a product or a service. For a particular third-party content provider that promotes multiple products in which a user is interested, the online system considers value of the products to the particular third-party content provider in addition to measuring the user's interest levels in the products when determining to present which product(s) to users.

In one approach, the online system allows third-party content providers to associate products in a product set with weights. A weight has a value that reflects a measure of a product's value to the third-party content provider. The third-party content provider provides a product catalog that includes information such as the product set and weights associated with the products to the online system. The catalog includes items that may or may not be related. The product catalog may further include product information such as a product identifier, a product name, a product description, a product image, a product location, a shipping information, a product review. The online system receives and stores the product catalog.

Upon detecting an impression opportunity to present a sponsored content item to a given user, the online system identifies one or more candidate sponsored content items and determines bid prices for the candidate sponsored content items. A candidate sponsored content item promotes one or more products in which the user is interested. The one or more products are selected based on the user's interest in the products as well as the value of the products to the third-party content providers. The online system evaluates the user's interest in a particular product by calculating a user score. In addition, the online system evaluates the product's value to the third-party content provider by the weight associated with the product, which it uses to weight a user preference score for the product to generate a weighted user preference score. The weighted user preference score is used to select one or more products to be promoted to a user in response to an impression opportunity.

The online system determines a bid price for presenting the candidate sponsored content item for the impression opportunity. In some embodiments, the bid price for a dynamic sponsored content item with a given product is determined based at least on the weighted user preference score for the product. The online system selects one from the candidate sponsored content items for presentation to the user in the impression opportunity. In one embodiment, the candidate sponsored content item with the highest bid price is selected for presentation to the user. A weight has a value that is set based on factors associated with a third-party content provider's internal goals such as a profit margin, a sale through, an inventory, a seasonality, a volume, a release date, a sales, a brand, a strategic partnership with a brand, or a corporate strategy. The online system can also propose weights for different products to the third-party content provider for consideration to use in the catalog as the assigned weights for those products.

### System Architecture

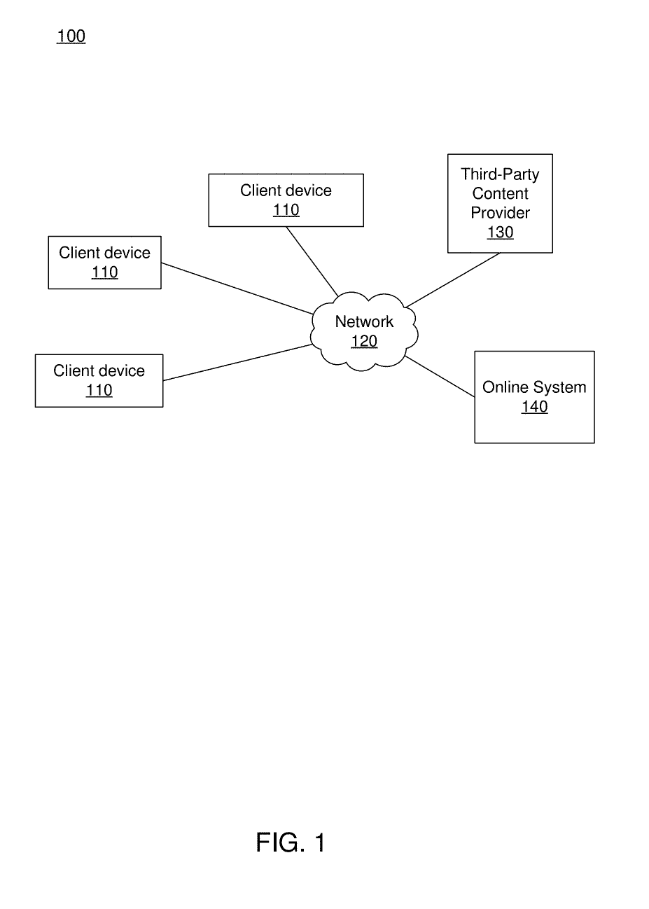

FIG. 1 is a block diagram of a system environment 100 for an online system 140. The system environment 100 shown by FIG. 1 comprises one or more client devices 110, a network 120, one or more third-party content providers 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140. The client devices 110 are configured to communicate via the network 120, which may comprise any combination of local area and/or wide area networks, using both wired and/or wireless communication systems. In one embodiment, the network 120 uses standard communications technologies and/or protocols.

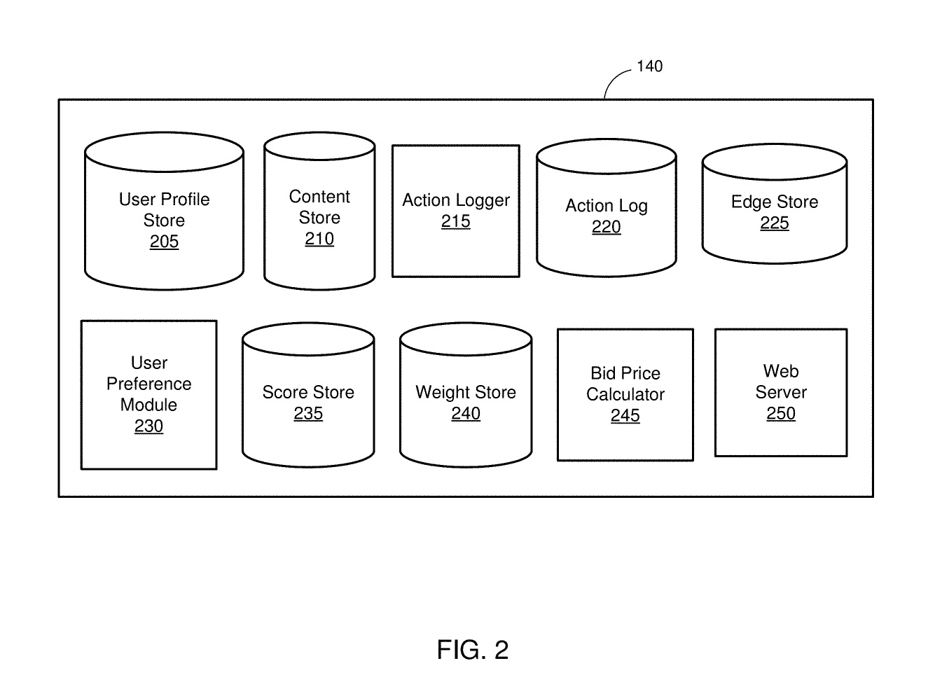

One or more third-party content providers 130 may be coupled to the network 120 for communicating with the online system 140, which is further described below in conjunction with FIG. 2. In one embodiment, a third-party content provider 130 is an application provider communicating information describing applications for execution by a client device 110 or communicating data to client devices 110 for use by an application executing on the client device 110. In other embodiments, a third-party content provider 130 provides content or other information for presentation via the client device 110.

As described below in detail with reference to FIGS. 2-5, the online system 140 receives a product catalog including products from the third-party content provider 130 for promotion via presentation of sponsored content items to users of the online system 140. The products may be related or unrelated. The online system 140 identifies a request for a sponsored content item. In response to the request, the online system 140 determines candidate sponsored content items from which one candidate sponsored content item is selected for presentation to the user. At least one of the candidate sponsored content items is a dynamic candidate sponsored content item for promotion of one or more products included in the product catalog. The one or more products are selected based at least on the user's interest as well as a value to the third-party content provider 130. For each candidate sponsored content items, the online system 140 determines a bid price. The online system 140 selects a sponsored content item from the candidate sponsored content items and provides for display to the client device 110 the selected sponsored content item.

FIG. 2 is a block diagram of an architecture of the online system 140. The online system 140 shown in FIG. 2 includes a user profile store 205, a content store 210, an action logger 215, an action log 220, an edge store 225, a user preference module 230, a score store 235, a weight store 240, a bid price calculator 245, and a web server 250. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an third-party content provider to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

In various embodiments, a content item includes various components capable of being identified and retrieved by the online system 140. Example components of a content item include: a title, text data, image data, audio data, video data, a landing page, a user associated with the content item, or any other suitable information. The online system 140 may retrieve one or more specific components of a content item for presentation in some embodiments. For example, the online system 140 may identify a title and an image from a content item and provide the title and the image for presentation rather than the content item in its entirety.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the third-party content provider. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In various embodiments, the content store 210 includes multiple campaigns, which each include one or more content items. In various embodiments, a campaign in associated with one or more characteristics that are attributed to each content item of the campaign. For example, a bid amount associated with a campaign is associated with each content item of the campaign. Similarly, an objective associated with a campaign is associated with each content item of the campaign. In various embodiments, a user providing content items to the online system 140 provides the online system 140 with various campaigns each including content items having different characteristics (e.g., associated with different content, including different types of content for presentation), and the campaigns are stored in the content store.

In one embodiment, targeting criteria may specify actions or types of connections between a user and another user or object of the online system 140. Targeting criteria may also specify interactions between a user and objects performed external to the online system 140, such as on a third-party content provider 130. For example, targeting criteria identifies users that have taken a particular action, such as sent a message to another user, used an application, joined a group, left a group, joined an event, generated an event description, purchased or reviewed a product or service using an online marketplace, requested information from a third-party content provider 130, installed an application, or performed any other suitable action. Including actions in targeting criteria allows users to further refine users eligible to be presented with content items. As another example, targeting criteria identifies users having a connection to another user or object or having a particular type of connection to another user or object.

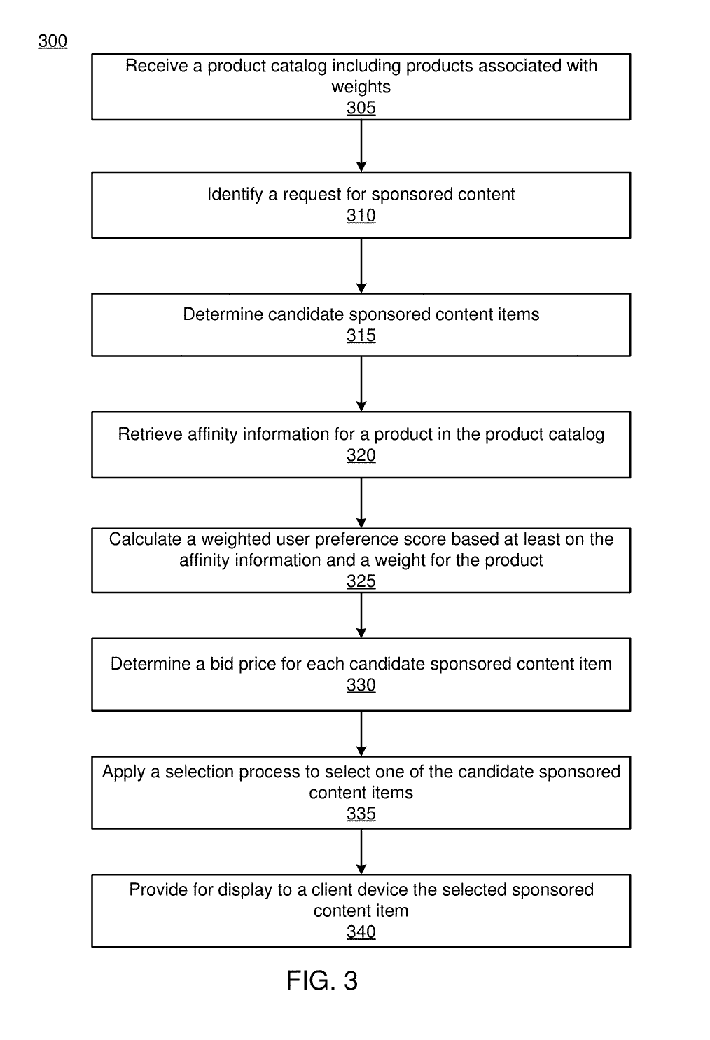

As described below in conjunction with FIGS. 3-5, the content store 210 receives a product catalog including one or more products from the third-party content provider 130 for promotion via sponsored content items to users of the online system 140. Each product in the product catalog may be associated with a weight having a value indicating a measure of importance of the product to the third-party content provider 130. The value of the weight can be selected from a value range that can be preconfigured by the online system 140 or defined by the third-party content provider 130. The measure of importance is an amount of value of the product to the third-party content provider 130. For example, a weight having a value of ‘1’ may correspond to a product of least importance to the third-party content provider 130 while a weight having a value of ‘10000’ may correspond to a product of most importance to the third-party content provider 130. The product catalog may further include information describing products and characteristics of the products. The content store 210 stores the product catalog received from the third-party content provider 130. The content store 210 may also store information identifying products in a product catalog that have been accessed by users of the online system 140 and accessing details such as a time point, a time interval, an interaction, or whether a user shares with another user the product or the sponsored content item promoting the product.

The action logger 215 receives communications about user actions internal to and/or external to the online system 140, and populates the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

In some configurations, the action logger 215 determines products associated with the third-party content provider 130 accessed by the user and accessed by one or more additional users within a time interval. For example, a user accessed a product related to consumer electronics on a weekend between 10 AM and 11 AM and shared information about the product to his/her connections on the online system 140. The online system 140 communicates with the action logger 215 to perform a ranking of the determined products based on the number of additional users who accessed each of the determined products. The online system 140 identifies products having a threshold position in the ranking.

The action log 220 may be used by the online system 140 to track user actions on the online system 140, as well as actions on third-party content providers 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with sponsored content items on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third-party content provider 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third-party content provider 130, including webpage viewing histories, sponsored content items that were engaged, purchases made, and other patterns from shopping and buying. Additionally, actions a user performs via an application associated with a third-party content provider 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140. Edges may connect two users who are connections in a social network, or may connect a user with an object in the system. In one embodiment, the nodes and edges form a complex social network of connections indicating how users are related or connected to each other (e.g., one user accepted a friend request from another user to become connections in the social network) and how a user is connected to an object due to the user interacting with the object in some manner (e.g., “liking” a page object, joining an event object or a group object, etc.). Objects can also be connected to each other based on the objects being related or having some interaction between them.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The user preference module 230 calculates a weighted user preference score for a product in the product catalog and determines one or more products for inclusion in a dynamic sponsored content item based at least on the calculated user preference scores. A weighted user preference score is a quantitative measure of the user's affinity for or interest in a product as well as an importance of the product to the third-party content provider 130. The user preference module 230 selects products for promotion in a dynamic sponsored content item based at least on the weighted user preference score. In some embodiments, the user preference module 230 selects a product for promotion of which the weighted user preference score is greater than a threshold. In some embodiments, the user preference module 230 ranks the products based on the calculated weighted user preference scores, for example, in a descending order. One or more products that have a threshold position in the ranking are selected for inclusion in the dynamic sponsored content item.

In some embodiments, the user preference module 230 calculates user preference scores responsive to identifying a request for sponsored content. The user preference module 230 may calculate user preference scores for products that are relevant to the request. For example, if an impression opportunity is requesting for female clothing and a product catalog includes products of both male and female clothing, the user preference module 230 calculates user preference scores only for the female clothing products. In some embodiments, the user preference module 230 calculates user preference scores for all products in a product catalog. The score store 235 stores the user preference scores determined by the user preference module 230.

The user preference module 230 retrieves affinity information from the edge store 225 indicating an affinity of the user to calculate the user preference score for a product. That is, the user preference score is calculated based at least on the retrieved affinity information. The user preference score has a value that reflects a degree of the user's affinity for the product. The user preference score is weighted by the weight stated for the product in the product catalog to calculate a weighted user preference score. The weighted user preference score has a value that reflects the user's affinity for the product and the product's importance to the third-party content provider.

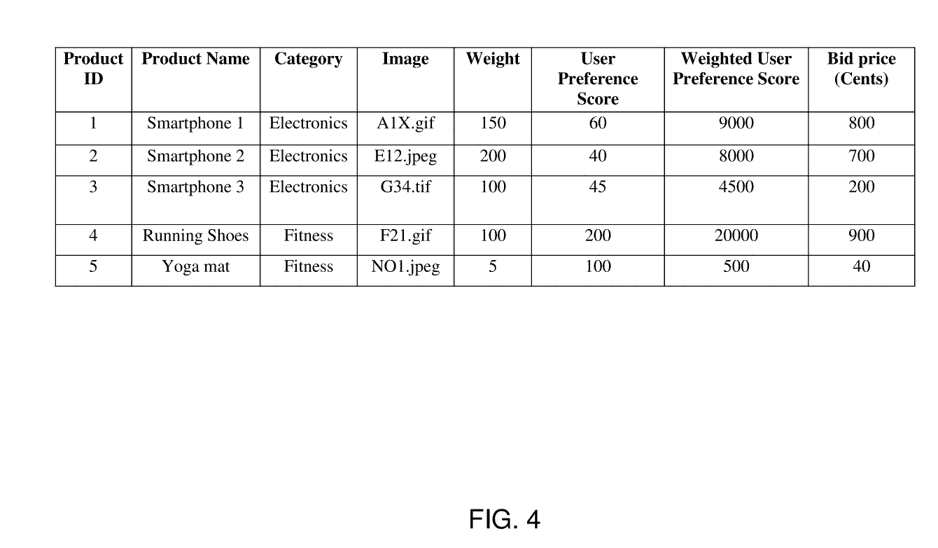

The weight store 240 stores for each product a weight indicating a measure of importance of the product to the third-party content provider 130. A weight may be determined based on product information selected one or more factors selected from a group consisting of: a profit margin, a sale through, an inventory information, seasonal fluctuation information, a release date, a sales information, a brand value, a corporate strategy, and some combination thereof. One example is further described in conjunction with FIG. 4.

In some embodiments, for a particular product, a weight has values that vary over time. For example, a value of a weight changes as a function of time within a time interval (e.g., a day, a month, a year). As a result, for a product catalog that includes products associated with time-variant weights, a dynamic content item can promote different products to a particular user at different time points within a particular time interval. The online system 140 calculates the value for the weight using the function and a current time relative to a time associated with the identification of a request for presentation of a sponsored content item to the user of the online system 140.

The bid price calculator 245 determines a bid price for presenting a dynamic sponsored content item to the user of the online system 140. In some embodiments, the bid price calculator 245 determines the bid price using the weighted user preference score.

The web server 250 links the online system 140 via the network 120 to the one or more client devices 110, as well as to the one or more third-party content providers 130. The web server 250 serves web pages, as well as other content, such as JAVA®, FLASH®, XML and so forth. The web server 250 may receive and route messages between the online system 140 and the client device 110, for example, instant messages, queued messages (e.g., email), text messages, short message service (SMS) messages, or messages sent using any other suitable messaging technique. A user may send a request to the web server 250 to upload information (e.g., images or videos) that are stored in the content store 210. Additionally, the web server 250 may provide application programming interface (API) functionality to send data directly to native client device operating systems, such as IOS®, ANDROID™, or BlackberryOS.

### Presenting Dynamic Sponsored Content Items Based on a Product Level Bidding

FIG. 3 is a flow chart 300 illustrating the process of presenting dynamic sponsored content items based on a product level bidding, in accordance with an embodiment.

As described above in conjunction with FIGS. 1-2, the online system 140 receives 305 a product catalog including products from the third-party content provider 130. Products included in the product catalog are for selection for promotion via sponsored content items to users of the online system 140. Each product in the product catalog is associated with a weight indicating a measure of importance of the product to the third-party content provider 130.

The online system 140 identifies 310 a request for sponsored content item. The request is received from a client device of a user of the online system 140, for example when a user logs onto the online system or refreshes a page within the online system, and there is an opportunity to present new content to the user. Responsive to the request, the online system 140 determines 315 candidate sponsored content items for the user. The user meets the targeting criteria specified by each candidate sponsored content item. The candidate content items include at least one dynamic sponsored content item in which the online system 140 selects the product for promotion from the product catalog.

For a product of the product catalog, the online system 140 retrieves 320 affinity information indicating affinity of the user for the product. In some embodiments, the online system 140 retrieves affinity information for products that are relevant to the request for sponsored content. The relevancy can be determined using product information specified in the product catalog. In some embodiments, the online system 140 retrieves affinity information for all products in the product catalog. The online system 140 calculates 325 a weighted user preference score based on the affinity information weighted by the weight associated with the product in the product catalog. In some configurations, the online system 140 calculates 325 the weighted user preference score for a given user relative to a product in the catalog responsive to identifying 310 the request to present the sponsored content item to the user of the online system 140. In alternate configurations, the online system 140 calculates 325 the weighted user preference score for the user for every product in the product catalog in advance, or at least for some of the products (e.g., the products most likely to be relevant to the user).

The online system 140 determines 330 a bid price for each candidate sponsored content item. In some embodiments, for a dynamic sponsored content item, the bid price is determined based at least on the weighted user preference score determined for the one or more products selected for promotion via the dynamic sponsored content item.

The online system 140 applies 335 a selection process (e.g., an ad auction) to select one of the candidate sponsored content items for presentation to the user via the identified request. In particular, the online system 140 includes the candidate sponsored content items with the determined bid prices. The online system 140 may rank the candidate sponsored content items based on the bid prices and/or a likelihood of the user interacting with the candidate sponsored content items. The online system 140 may select a highest-ranked candidate sponsored content item for presentation to the user.

The online system 140 provides 340 for display to the client device 110 the selected sponsored content item.

### Example of Selecting Products for Inclusion in a Dynamic Content Item

FIG. 4 is an example of selecting products from a product catalog for inclusion in a dynamic content item, in accordance with an embodiment. The illustrated example shows five different products—“smartphone 1,” “smartphone 2,” and “smartphone 3” under the “electronics” category, “running shoes” and “yoga mat” under the “fitness” category. The five products are associated with weights have different values. Among them, the product “smartphone 2” is of most importance to this particular third-party content provider. The product “smartphone 1” is of the second importance, followed by the products “smartphone 3” and “running shoes.” The product “yoga mat” is of the least importance to the third-party content provider. For the purpose of discussion here, all five products are assumed to be relevant to a user's request for sponsored content item.

The third-party content provider 130 favors selling more products under the “electronics” category than those under the “fitness” category, which is reflected by the weights' values. However, this particular user is more interested in products under the “fitness” category than products under the “electronics” category, which is reflected by the user preference scores calculated for the products.

The online system 140 considers the third-party content provider's 130 preference in products along with the user's affinity for the products when selecting one or more products for inclusion in sponsored content. The online system 140 calculates a weighted user preference score for each product (or for at least some products) for each given user. In some cases, these scores are calculated at the time of the impressions opportunity for a given user, as the products are being considered for presentation to the user. In other cases, some or all of these scores are calculated in advance for the user for some or all of the products. Scores calculated at impression time can also be stored and re-used in later impressions for that user. As illustrated, the product “running shoes” has the highest weighted user preference score, followed by the products “smartphone 1,” “smart phone 2,” and “smart phone 3” in a descending order. The product “yoga mat” has the lowest weighted user preference score.

The online system 140 selects the product “running shoes” for promotion to the user. In some embodiments, the online system 140 calculates the bid prices based at least on the weighted user preference scores. As illustrated, the bid prices determined for sponsored content items promoting the different products listed in the product catalog are in the same order as the weighted user preference scores determined for the products. These bid prices can be calculated at impression time, or in some embodiments, some bid prices can be calculated in advance and stored.

The weights associated with the products can vary with time. Accordingly, for the same particular user, the online system 140 may select to promote different products at different time points. For example, the third-party content provider may increase the weights for the products under the “electronics” category before school starts, and the online system 140 may select to promote “smartphone 2” rather than “running shoes.”

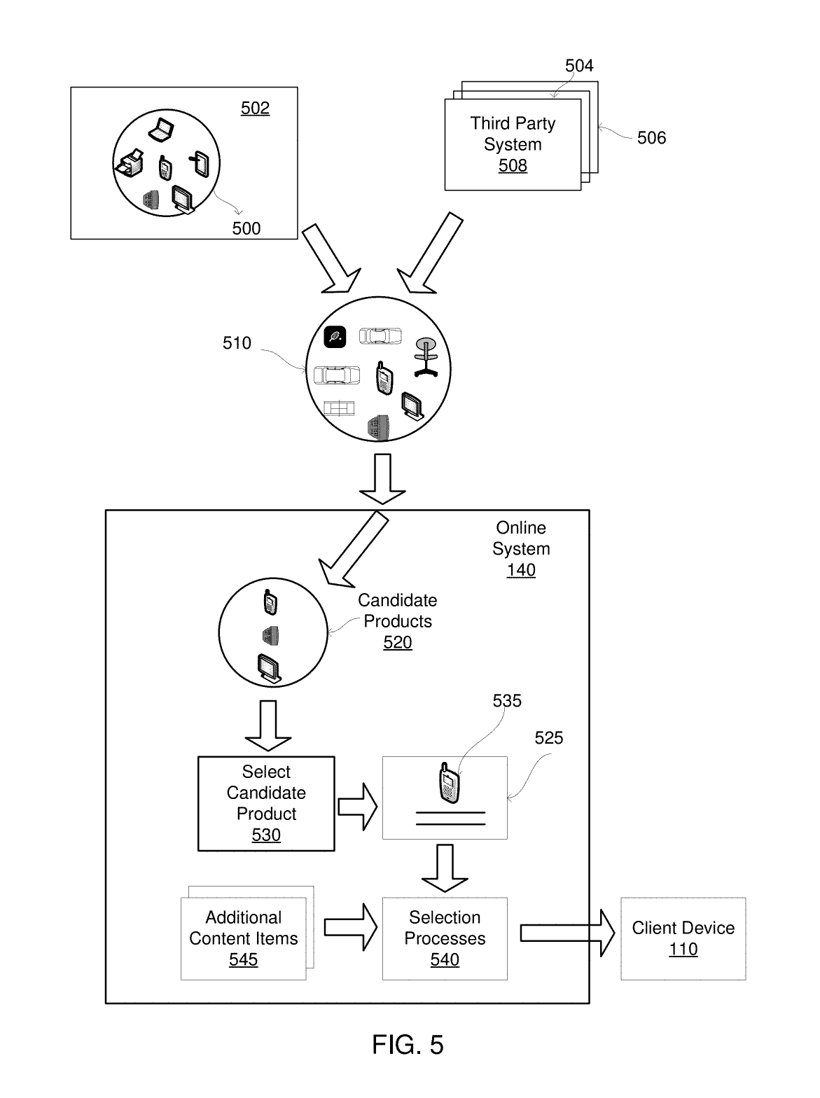

FIG. 5 illustrates an example of an online system 140 presenting dynamic sponsored content items based on a product level bidding, in accordance with one embodiment. As described above in conjunction with FIGS. 1-4, the online system 140 obtains product information 500 from a third-party content provider 504. For example, the third-party content provider 504 provides the online system 140 with product information 500 such as identifiers of various products associated with the third-party content provider 504, and information about the products. The information about the products include characteristics of various products associated with the third-party content provider 504 (e.g., descriptions of products, keywords associated with products, pricing information for products, or any other suitable information). The online system 140 may periodically request the product information 500 from the third-party content provider 504. Additionally or alternatively, the third-party content provider 504 may provide the product information 500 to the online system 140 without receiving a request from the online system 140. For example, the third-party content provider 504 provides product information 500 associated with a new product (e.g., a product newly offered for sale by the third-party content provider 504). As another example, the third-party content provider 504 periodically communicates product information 500 to the online system 140.

The online system 140 also receives product information describing products 510 that are associated with various third-party content providers 504, 506, 508 accessed by users of the online system 140, as further described above in conjunction with FIG. 2. In some embodiments, the products 510 are accessed by a user of the online system 140. The online system 140 may receive information about other products that are not accessed by the user but are accessed by additional users of the online system 140. While FIG. 5 shows an example where the online system 140 receives information describing products 510 that are associated with third-party content providers 504, 506, 508 and accessed by the user, in other embodiments, the online system 140 receives information identifying content associated with various third-party content providers 504, 506, 508 accessed by the user and identifies products 510 associated with the third-party content providers 504, 506, 508 that the user accessed from the content accessed by the user. For example, various third-party content providers 504, 506, 508 include tracking mechanisms in content provided by the third-party content provider 504, 506, 508. A tracking mechanism comprises instructions that, when executed by a client device 110 presenting the content, communicate information to the online system 140 identifying one or more products 510 included in the accessed content or identifying one or more products 510 accessed by a user of the client device 110 via the presented content. Different third-party content providers 504, 506, 508 include tracking mechanisms in various content provided by the third-party content providers 504, 506, 508 to provide information to the online system 140 identifying content from the various third-party content providers 504, 506, 508 presented to the user. The online system 140 stores information identifying products 510 associated with a third-party content provider 504, 506, 508 accessed by a user in association with the user and in association with the third-party content provider 504, 506, 508 associated with the products 510 to maintain a log of products 510 associated with one or more third-party content providers 504, 506, 508 that the user has accessed. In other embodiments, the online system 140 may receive the information describing products 510 accessed by the user from third-party content providers 504, 506, 508 themselves or from any suitable source.

When the online system 140 identifies an opportunity to present content to a user and the content item is eligible for presentation to the user, as further described above in conjunction with FIGS. 2 and 3, the online system 140 identifies candidate products 520 that are considered for inclusion in a dynamic sponsored content item. The online system 140 identifies the candidate product 520 associated with the third-party content provider 130 based on the information 500 identifying products associated with the third-party content provider 504 and products 510 associated with various third-party content providers 504, 506, 508 accessed by the user, as further described above in conjunction with FIGS. 1-2. In various embodiments, the online system 140 identifies the candidate products 520 based on products 510 associated with various third-party content providers 504, 506, 508. For example, the online system 140 identifies candidate products 520 as products associated with the third-party content provider 504 from the information 500 received from the third-party content provider 504 having at least a threshold percentage of characteristics matching characteristics of products 510 identified by one or more third-party content providers 504, 506, 508 as products 510 with which the user interacted. As another example, the online system 140 identifies candidate products 520 as products associated with the third-party content provider 504 from the information 500 received from the third-party content provider 504 having characteristics matching characteristics of products 510 associated with third-party content providers 504, 506, 508 with which at least a threshold number of additional users interacted.

The online system 140 may optionally generate a creative for the content item 525 including content describing the selected product 535, which is selected from the candidate products 520 as further described above and in conjunction with FIG. 3. For example, the online system 140 generates a creative for the content item 525 including an image, a name, and a description of the selected product 535. Hence, the online system 140 dynamically generates content for the creative of the content item 530 for presentation to the user based on products 510 associated with one or more third-party content providers 504, 506, 508 previously accessed by the user and products associated with the third-party content provider 130 specified by the information 500 received from the third-party content provider 504, so the content item 525 may present different content to different users and have a creative including content describing a product associated with the third-party content provider 504 likely to be relevant to the user.

In various embodiments, the online system 140 applies one or more models to characteristics of the content item 525 and to characteristics of the additional content items 545 to determine likelihoods of the user interacting with the content item 525 and with the additional content items 545. Hence, the content communicated from the online system 140 to the client device 110 is more likely to be content with which the user interacts.

### Conclusion

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at an online system, a product catalog including a plurality of products from a third-party content provider for selection to be presented in sponsored content items to users of the online system, each product having a weight indicating a measure of importance to the third-party content provider;
identifying, by the online system, a request for presentation of a sponsored content item to a user of the online system;
responsive to the request, determining a plurality of candidate sponsored content items, the candidate content items including at least a dynamic sponsored content item for presenting at least one of the products from the product catalog;
for each product of the product catalog being considered for the dynamic sponsored content item:
retrieving, by the online system, affinity information indicating affinity of the user for the product, and
calculating a weighted user preference score based on the affinity information weighted by the weight stated for the product in the product catalog,
selecting the at least one of the products from the product catalog for inclusion in the dynamic sponsored content item based at least on the weighted user preference scores determined for the products;
determining, by the online system, a bid price for presenting to the user the dynamic sponsored content item based on the weighted user preference score,
including the dynamic sponsored content item with the determined bid price in a selection process, for selecting one of the candidate sponsored content items for presentation to the user; and
providing for display to a client device the selected sponsored content item.

2. The method of claim 1, further comprising:
obtaining, at the online system, information from the third-party content provider describing characteristics of the one or more products associated with the third-party content provider;
receiving information identifying products associated with the third-party content provider accessed by a user; and
receiving information identifying products associated with the third-party content provider accessed by one or more additional users of the online system.

3. The method of claim 1, further comprising:
selecting a set of products from the one or more products for the dynamic sponsored content item based on:
determining products associated with the third-party content provider accessed by the user and accessed by one or more additional users within a time interval;
ranking the determined products based on a number of additional users who accessed each of the determined products; and
identifying the set of products having at least a threshold position in the ranking.

4. The method of claim 1, wherein selecting the at least one of the products from the product catalog for inclusion in the dynamic sponsored content item based at least on the weighted user preference scores determined for the products comprises:
ranking the one or more sponsored content items based on the weighted user preference score; and
selecting at least one of the products having a threshold position in the ranking.

5. The method of claim 1, wherein selecting the at least one of the products from the product catalog for inclusion in the dynamic sponsored content item based at least on the weighted user preference scores determined for the products comprises selecting at least one of the product having a threshold weighted user preference score.

6. The method of claim 1, wherein the weight has one or more values changing as a function of time, the value of the weight calculated based on a current time relative to a time associated with the identification of the request for presentation of the sponsored content item to the user of the online system.

7. The method of claim 1, further comprising:
responsive to the request, identifying a subset of the products included in the product catalog considered for the dynamic sponsored content item, an identified product relevant to the dynamic sponsored content item.

8. The method of claim 1, wherein the one or more weights are applied based on the product information selected from a group consisting of: a product identifier, a product name, a product description, a product image, a product location, a shipping information, a product review, and some combination thereof.

9. The method of claim 1, wherein the one or more weights are selected from a group consisting of: a profit margin, a sale through, an inventory, a seasonality, a volume, a release date, a sales, a brand value, a corporate strategy, and a strategic partnership with a brand, and some combination thereof.

10. An online system for displaying sponsored content items, the online system comprising a server configured to:
receive, at an online system, a product catalog including a plurality of products from a third-party content provider for selection to be presented in sponsored content items to users of the online system, each product having a weight indicating a measure of importance to the third-party content provider;
identify, by the online system, a request for presentation of a sponsored content item to a user of the online system;
responsive to the request, determine a plurality of candidate sponsored content items, the candidate content items including at least a dynamic sponsored content item for presenting at least one of the products from the product catalog;
for each product of the product catalog being considered for the dynamic sponsored content item:
retrieve, by the online system, affinity information indicating affinity of the user for the product, and
calculate a weighted user preference score based on the affinity information weighted by the weight stated for the product in the product catalog,
select at least one of the products from the product catalog for inclusion in the dynamic sponsored content item based at least on the weighted user preference scores determined for the products;
determine, by the online system, a bid price for presenting to the user the dynamic sponsored content item based on the weighted user preference score,
include the dynamic sponsored content item with the determined bid price in a selection process, for selecting one of the candidate sponsored content items for presentation to the user; and
provide for display to a client device the selected sponsored content item.

11. The online system of claim 10, further comprising a server configured to:
obtain, at the online system, information from the third-party content provider describing characteristics of the one or more products associated with the third-party content provider;
receive information identifying products associated with the third-party content provider accessed by a user; and
receive information identifying products associated with the third-party content provider accessed by one or more additional users of the online system.

12. The online system of claim 10, further comprising a server configured to:
select a set of products from the one or more products for the dynamic sponsored content item based on:
determine products associated with the third-party content provider accessed by the user and accessed by one or more additional users within a time interval;
rank the determined products based on a number of additional users who accessed each of the determined products; and
identify the set of products having at least a threshold position in the ranking.

13. The online system of claim 10, wherein selecting at least one of the products from the product catalog for inclusion in the dynamic sponsored content item based at least on the weighted user preference scores determined for the products by the server comprises:
ranking the one or more sponsored content items based on the weighted user preference score; and
selecting at least one of the products having a threshold position in the ranking.

14. The online system of claim 10, wherein selecting the at least one of the products from the product catalog for inclusion in the dynamic sponsored content item based at least on the weighted user preference scores determined for the products by the server comprises selecting at least one of the product having a threshold weighted user preference score.

15. The online system of claim 10, wherein the weight has one or more values changing as a function of time, the value of the weight calculated based on a current time relative to a time associated with the identification of the request for presentation of the sponsored content item to the user of the online system.

16. The online system of claim 10, further comprising a server configured to:
responsive to the request, identify a subset of the products included in the product catalog considered for the dynamic sponsored content item, an identified product relevant to the dynamic sponsored content item.

17. The online system of claim 10, wherein the one or more weights are applied based on the product information selected from a group consisting of: a product identifier, a product name, a product description, a product image, a product location, a shipping information, a product review, and some combination thereof.

18. The online system of claim 10, wherein the one or more weights are selected from a group consisting of: a profit margin, a sale through, an inventory, a seasonality, a volume, a release date, a sales, a brand value, a corporate strategy, a strategic partnership with a brand, and some combination thereof.

19. A method comprising:
receiving, at an online system, a product catalog including a plurality of products from a third-party content provider for selection to be presented in sponsored content items to users of the online system, each product having a weight indicating a measure of importance of the product to the third-party content provider;
identifying, by the online system, a request for presentation of a sponsored content item to a user of the online system;
responsive to the request, determining a plurality of candidate sponsored content items, the candidate content items including at least a dynamic sponsored content item for presenting at least one of the products from the product catalog;
for each product of the product catalog being considered for the dynamic sponsored content item:
retrieving, by the online system, affinity information indicating affinity of the user for the product, and
calculating a weighted user preference score based on the affinity information weighted by the weight stated for the product in the product catalog,
determining, by the online system, a bid price for presenting to the user the dynamic sponsored content item with a product from the product catalog based on the weighted user preference score for the product; and
providing for display to a client device the sponsored content item with the product in response to the dynamic sponsored content item with the product being selected in a selection process over other candidate sponsored content items based on the bid price.

20. The method of claim 19, further comprising:
responsive to the request, identifying a subset of the products included in the product catalog considered for the dynamic sponsored content item, an identified product relevant to the dynamic sponsored content item.
